(19) United States
(12) Patent Application Publication
(10) Pub. No.: US 2026/0129116 A1
(43) Pub. Date: May 7, 2026

(54) SMART MOBILE PHONE CASE WITH DISPLAY SCREEN

(71) Applicant: Shenzhen Noor Trading Co.,Ltd, Shenzhen (CN)

(72) Inventor: Xiaoyang GUO, Shenzhen (CN)

(73) Assignee: Shenzhen Noor Trading Co.,Ltd, Shenzhen (CN)

(21) Appl. No.: 18/937,640

(22) Filed: Nov. 5, 2024

(51) Int. Cl. H04M 1/72466; H04M 1/02; H04M 1/22

(52) U.S. Cl. CPC H04M 1/72466; H04M 1/0266; H04M 1/0274; H04M 1/22

(57) ABSTRACT

The present invention relates to the technical field of mobile phone case display, and discloses a smart mobile phone case with a display screen, including a mobile phone shell, a cover plate and an FPC board; the FPC board being provided with a display screen, a battery and a central microprocessor; and function keys, a customized key, a touchpad and a mic audio sensor being installed on the mobile phone shell. The customized key is used for rapidly controlling a mobile phone system and achieving a function of one-click execution by using shortcuts; and the mic audio sensor can collect external environmental sound, and parse and compile the external environmental sound; and an inductive touch module has functions of human body induction and trigger. Display contents of the mobile phone case can be conveniently and rapidly switched, so that the use experience of a user is enhanced.

### TECHNICAL FIELD

The present invention relates to the technical field of mobile phone case display, in particular to a smart mobile phone case with a display screen.

### BACKGROUND

In the prior art, a mobile phone case is a protective case. However, although the mobile phone case has various styles, they are lack of flexibility. Due to a relatively single function, pattern contents of the mobile phone case cannot be replaced at any time, and better convenient functions are not provided on the level of facilitating operation.

Therefore, how to provide a smart mobile phone case with a display screen so as to conveniently and rapidly switch display contents of the mobile phone case has become an urgent technical problem to be solved.

### SUMMARY

The technical problem to be solved by the present invention is to provide a smart mobile phone case with a display screen so as to conveniently and rapidly switch display contents of the mobile phone case.

For this purpose, according to a first aspect, an embodiment of the present invention discloses a smart mobile phone case with a display screen, including a mobile phone shell for sleeving a mobile phone and a cover plate, wherein the cover plate is made of a light transmitting material, and the mobile phone shell is made of a plastic material;
an FPC board connected to the mobile phone by means of a signal is installed in the mobile phone shell, the FPC board is provided with a mic audio sensor used for achieving a radio receiving function, a display screen, a battery and a touchpad used for triggering the display screen to be lighted for display, function keys and a customized key are installed on the mobile phone shell, the function keys are used for controlling the power on or off and volume adjustment of the mobile phone, and the customized key is used for rapidly controlling a mobile phone system and achieving a function of one-click execution by using shortcuts; and
a protective die cutting material in contact with the mobile phone is installed in the mobile phone shell, and the protective die cutting material is bonded to the FPC board and is made of a soft material.

The present invention is further set as that the bottom of the FPC board is provided with a mobile phone connector spliced with the mobile phone.

The present invention is further set as that the mobile phone connector is a Type-C or Lightning connector.

The present invention is further set as that the protective die cutting material is made of flocked cloth or suede.

The present invention is further set as that the display screen consists of a plurality of RGB LED lamps distributed in a matrix.

The present invention is further set as that a shading grid is installed in the mobile phone shell, and the RGB LED lamps are embedded into the shading grid.

The present invention is further set as that a light homogenizing film is installed in the mobile phone shell and is located between the display screen and the cover plate.

The present invention is further set as that the bottom of the FPC board is provided with a charging connector used for connecting an external power source and charging the battery.

The present invention has the following beneficial effects: the function keys and the customized key are installed on the mobile phone shell, the FPC board is provided with the display screen, the customized key is used for rapidly controlling the mobile phone system and achieving the function of one-click execution by using the shortcuts; and thus, provided is the smart mobile phone case with the display screen. The customized key has the function of one-click execution and can conveniently and rapidly switch display contents of the mobile phone case, so that the use experience of a user is enhanced.

### BRIEF DESCRIPTION OF DRAWINGS

In order to describe technical solutions in specific implementations of the present invention or the prior art more clearly, the accompanying drawings required for describing the specific implementations or the prior art will be briefly introduced below. Apparently, the accompanying drawings in the following description show only some implementations of the present invention, and those of ordinary skill in the art can still derive other accompanying drawings from these accompanying drawings without creative work.

FIG. 1 is a schematic structural diagram of a smart mobile phone case with a display screen disclosed in the present embodiment;

FIG. 2 is a schematic structural diagram of a smart mobile phone case with a display screen disclosed in the present embodiment; and

FIG. 3 is a schematic structural diagram of a smart mobile phone case with a display screen disclosed in the present embodiment.

Reference numerals in the accompanying drawings: 1, mobile phone shell; 2, cover plate; 3, FPC board; 31, touchpad; 4, display screen; 5, battery; 6, function key; 7, customized key; 8, protective die cutting material; 9, mobile phone connector; 10, RGB LED lamp; 11, shading grid; 12, light homogenizing film; 13, charging connector; and 14, mic audio sensor.

### DETAILED DESCRIPTION OF THE EMBODIMENTS

In order to make objects, technical solutions and advantages of the present invention clearer and more understandable, the present invention will be further described below in detail in conjunction with the accompanying drawings and embodiments. It should be understood that the specific embodiments described herein are only intended to explain the present invention, rather than to limit the present invention.

In the description of the present invention, it is to be noted that unless otherwise expressly specified and limited, terms “mounted”, “connected”, and “connection” should be understood in a broad sense, for example, it can be fixed connection or detachable connection or integrated connection; it can be mechanical connection or electrical connection; and it can be direct connection, indirect connection through an intermediate medium, internal communication between two elements, wireless connection or wired connection. The specific meanings of the above-mentioned terms in the present invention can be understood in specific situations by those of ordinary skill in the art.

In the description of the present invention, it should be noted that directional or positional relationships indicated by terms such as “center”, “upper”, “lower”, “left”, “right”, “vertical”, “horizontal”, “inner” and “outer” are directional or positional relationships based on the accompanying drawings, are only intended to facilitate describing the present invention and simplifying the description, rather than to indicate or imply that the appointed device or element has to be located in a specific direction or structured and operated in the specific direction so as not to be understood as restrictions on the present invention. In addition, terms “first”, “second” and “third” are for descriptive purposes only, and cannot be understood as indicating or implying the relative importance.

In addition, technical features involved to different implementations in the following description of the present invention can be combined with each other without any conflicts.

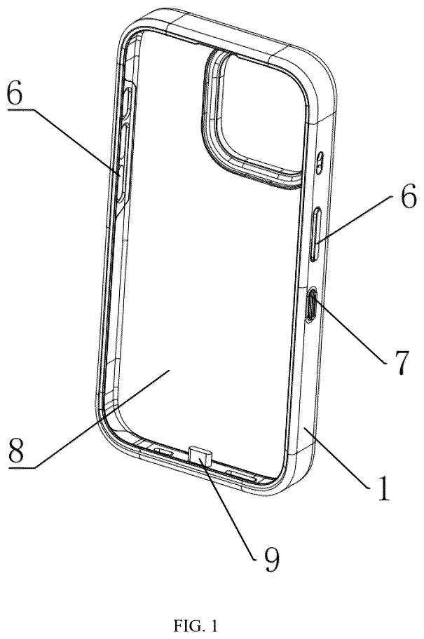

An embodiment of the present invention discloses a smart mobile phone case with a display screen, as shown in FIGS. 1 to 3, including a mobile phone shell 1 for sleeving a mobile phone and a cover plate 2, wherein the cover plate 2 is made of a light transmitting material, and the mobile phone shell 1 is made of a silica gel material;
an FPC board 3 connected to the mobile phone by means of a signal is installed in the mobile phone shell 1, the FPC board 3 is provided with a mic audio sensor 14 used for achieving a radio receiving function, a display screen 4, a battery 5, a central microprocessor and a touchpad 31 used for triggering the display screen 4 to be lighted for display, function keys 6 and a customized key 7 are installed on the mobile phone shell 1, the function keys 6 are used for controlling the power on or off and volume adjustment of the mobile phone, and the customized key 7 is used for rapidly controlling a mobile phone system and achieving a function of one-click execution by using shortcuts; and
a protective die cutting material 8 in contact with the mobile phone is installed in the mobile phone shell 1, and the protective die cutting material 8 is bonded to the FPC board 3 and is made of a soft material. During specific implementation, the FPC board 3 is electrically connected with the mic audio sensor 14, external source is collected by the mic audio sensor 14, then, dynamic image display of the display screen 4 can be matched, and thus, the function and interestingness of the smart mobile phone case are enhanced. The touchpad 31 is installed on the FPC board 3, and triggering the display screen 4 to be lighted for display can be achieved by touching the touchpad 31. The mic audio sensor 14 can collect external environmental sound, and parse and compile, by means of a chip, the external environmental sound as a visual dynamic image to be displayed in an LED display screen of the mobile phone case, so that the music entertainment of the mobile phone case is greatly improved.

It should be noted that the function keys 6 and the customized key 7 are installed on the mobile phone shell 1, the FPC board 3 is provided with the display screen 4, the customized key 7 is used for rapidly controlling the mobile phone system and achieving the function of one-click execution by using the shortcuts; and thus, provided is the smart mobile phone case with the display screen. The customized key 7 has the function of one-click execution and can conveniently and rapidly switch display contents of the mobile phone case, so that the use experience of a user is enhanced. The customized key 7 can interact with a mobile phone system layer. For example, after the key is pressed down, a specified mobile phone app or other more complex operations can be started.

It should be further noted that the mobile phone can transmit notifications according to an ANCS protocol after being connected to the mobile phone case by means of Bluetooth. After receiving the notifications, the mobile phone can correspondingly display reminding pictures, and supports customization. Various apps can be conveniently and rapidly started by shortcut keys on the mobile phone according to an HID protocol in cooperation with the mobile phone system, and the function of one-click execution can be achieved by using the shortcuts.

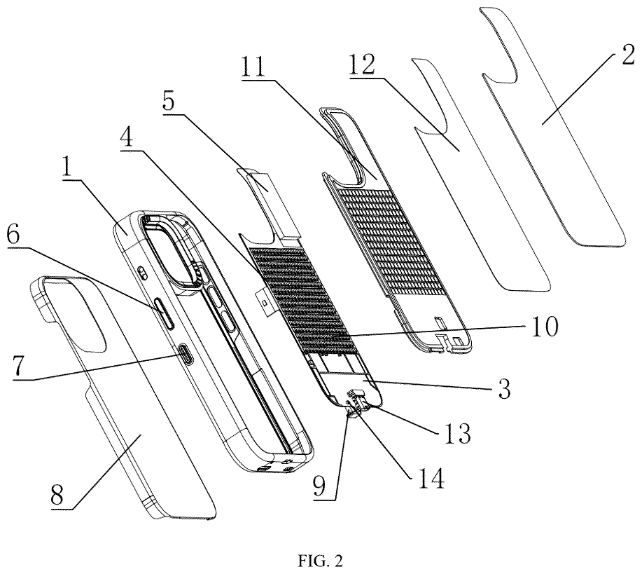

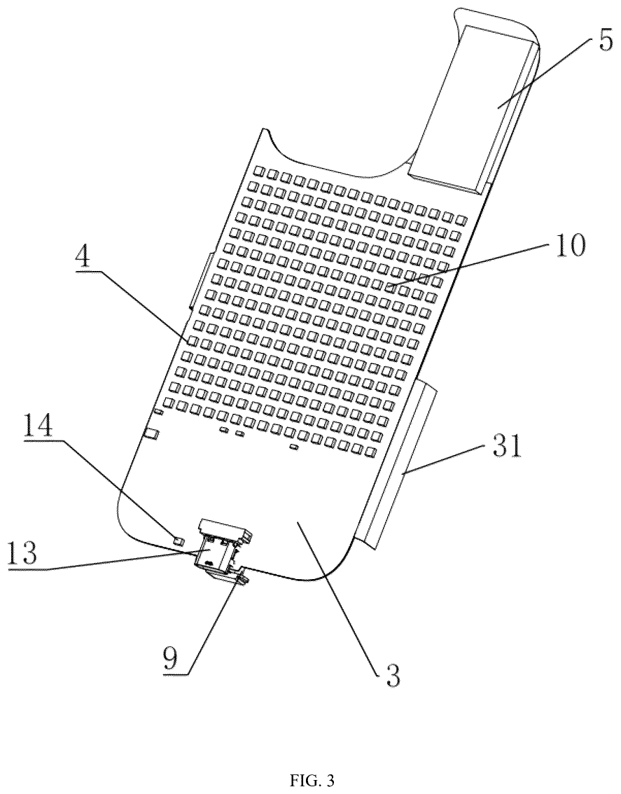

As shown in FIG. 2 and FIG. 3, the bottom of the FPC board 3 is provided with a mobile phone connector 9 spliced with the mobile phone.

As shown in FIG. 2 and FIG. 3, the mobile phone connector 9 is a Type-C or Lightning connector. It should be noted that the mobile phone connector 9 is the Type-C or Lightning connector, so that rapid signal connection between the mobile phone and the smart mobile phone case is achieved.

As shown in FIGS. 1 to 3, the protective die cutting material 8 is made of flocked cloth or suede. It should be noted that the protective die cutting material 8 is made of the flocked cloth or suede, so that the mobile phone can be better protected.

As shown in FIG. 2 and FIG. 3, the display screen 4 consists of a plurality of RGB LED lamps 10 distributed in a matrix.

As shown in FIGS. 1 to 3, a shading grid 11 is installed in the mobile phone shell 1, and the RGB LED lamps 10 are embedded into the shading grid 11. It should be noted that the shading grid 11 plays a role in blocking light emitted by sides of the adjacent RGB LED lamps 10 to avoid blurred edges of pixel points of patterns due to the interference of light from the adjacent RGB LED lamps 10, thereby ensuring the normal operation of the display screen 4.

As shown in FIGS. 1 to 3, a light homogenizing film 12 is installed in the mobile phone shell 1 and is located between the display screen 4 and the cover plate 2. It should be noted that due to the arrangement of the light homogenizing film 12 having the characteristic of translucent sanding, the light emitted by the RGB LED lamps 10 can be mutually refracted to form uniform light.

As shown in FIG. 2 and FIG. 3, the bottom of the FPC board 3 is provided with a charging connector 13 used for connecting an external power source and charging the battery 5. It should be noted that, by disposing the charging connector 13, the smart mobile phone case and the mobile phone can be charged at the same time.

Working principle: the function keys 6 and the customized key 7 are installed on the mobile phone shell 1, the FPC board 3 is provided with the display screen 4, the customized key 7 is used for rapidly controlling the mobile phone system and achieving the function of one-click execution by using the shortcuts; and thus, provided is the smart mobile phone case with the display screen. The customized key 7 has the function of one-click execution and can conveniently and rapidly switch display contents of the mobile phone case, so that the use experience of a user is enhanced.

Apparently, the above-mentioned embodiments are only intended to clearly describe examples, rather than to limit the implementations. Those of ordinary skill in the art can also make other variations or alterations in different forms on the basis of the above-mentioned description. It is unnecessary and impossible to exhaustively list all the implementations herein. Apparent variations or alterations derived from these still fall within the protective scope of the present invention.

1. A smart mobile phone case with a display screen, comprising a mobile phone shell (1) for sleeving a mobile phone and a cover plate (2), wherein the cover plate (2) is made of a light transmitting material, and the mobile phone shell (1) is made of a plastic material;
a flexible printed circuit (FPC) board (3) connected to the mobile phone by means of a signal is installed in the mobile phone shell (1), the FPC board (3) is provided with a mic audio sensor (14) used for achieving a radio receiving function, a display screen (4), a battery (5) and a touchpad (31) used for triggering the display screen (4) to be lighted for display, function keys (6) and a customized key (7) are installed on the mobile phone shell (1), the function keys (6) are used for controlling the power on or off and volume adjustment of the mobile phone, and the customized key (7) is used for rapidly controlling a mobile phone system and achieving a function of one-click execution by using shortcuts; and
a protective die cutting material (8) in contact with the mobile phone is installed in the mobile phone shell (1), and the protective die cutting material (8) is bonded to the FPC board (3) and is made of a soft material.

2. The smart mobile phone case with the display screen of claim 1, wherein the bottom of the FPC board (3) is provided with a mobile phone connector (9) spliced with the mobile phone.

3. The smart mobile phone case with the display screen of claim 2, wherein the mobile phone connector (9) is a Type-C or Lightning connector.

4. The smart mobile phone case with the display screen of claim 1, wherein the protective die cutting material (8) is made of flocked cloth or suede.

5. The smart mobile phone case with the display screen of claim 1, wherein the display screen (4) consists of a plurality of red-green-blue light emitting diode (RGB LED) lamps (10) distributed in a matrix.

6. The smart mobile phone case with the display screen of claim 5, wherein a shading grid (11) is installed in the mobile phone shell (1), and the RGB LED lamps (10) are embedded into the shading grid (11).

7. The smart mobile phone case with the display screen of claim 5, wherein a light homogenizing film (12) is installed in the mobile phone shell (1) and is located between the display screen (4) and the cover plate (2).

8. The smart mobile phone case with the display screen of claim 1, wherein the bottom of the FPC board (3) is provided with a charging connector (13) used for connecting an external power source and charging the battery (5).

9. The smart mobile phone case with the display screen of claim 6, wherein a light homogenizing film (12) is installed in the mobile phone shell (1) and is located between the display screen (4) and the cover plate (2).
